(19) United States
(12) Patent Application Publication
(10) Pub. No.: US 2009/0231775 A1
(43) Pub. Date: Sep. 17, 2009

(54) Submersible protection device

(76) Inventor: Rich Coppersmith, Lexington, KY (US)

Correspondence Address: STOCKWELL & SMEDLEY, PSC, 861 CORPORATE DRIVE, SUITE 200, LEXINGTON, KY, 40503, US

(21) Appl. No.: 12/077,123

(22) Filed: Mar. 17, 2008

(51) Int. Cl. H05C 1/00

(52) U.S. Cl. 361/232

(57) ABSTRACT

A submersible protection device comprises a housing, at least two electrically conductive probes, an electric circuit, and a voltage supply. The housing defines a substantially fluid tight chamber therein, and the at least two electrically conductive probes extend from the housing. The electric circuit is disposed in the substantially fluid tight chamber of the housing and is in electrical communication with the electrically conductive probes. The electric circuit is adapted to provide an output voltage to the electrically conductive probes and to provide an output current to the electrically conductive probes. The voltage supply delivers an input voltage to the electric circuit.

### BACKGROUND OF THE INVENTION

1. Field of the Invention

The present invention relates generally to a protection device and, more particularly, to a submersible protection device that can be safely used underwater on targets coming into close proximity to a user.

2. Description of Related Art

Protection against aquatic animals can be a problem associated with marine sports, such as diving, fishing, and the like. For example, divers may encounter dangerous aquatic animals, such as sharks, for instance, while performing a salt water dive. To provide desired protection from such aquatic animals, devices have been developed to repel animals from close proximity to the devices.

Certain prior art devices are directed to providing an electric field, which may be used to incapacitate or repel an aquatic animal or, in some cases, actually kill the aquatic animal when it enters an area within a certain range from the device. A common problem associated with these types of devices is safety of the user of the device, as a number of the devices may inadvertently inflict harm upon or even kill the user.

One specific prior art device is disclosed in U.S. Pat. No. 4,667,431 issued to Mendicino. The '431 patent discloses a device comprising an elongate prod having an end including a pair of electrically conductive prongs. Due to the elongate nature of the prod, a target must be located at a sufficient distance from the user (i.e. the length of the prod) so the prongs can be caused to contact the target. Accordingly, use of the prod on a target within very close proximity to the user (i.e. within the length of the prod) is not facilitated. Further, the prongs deliver a current of between 1 and 5 amperes to the target, and therefore must be located at a sufficient distance from the user to avoid the user being seriously injured or killed from the 1 to 5 ampere current.

There exists a need to develop a device capable of providing protection from aquatic animals that is capable of being used on targets coming into very close proximity to a user without the user being injured by the device.

### BRIEF SUMMARY OF THE INVENTION

Harmonious with the present invention, a submersible protection device capable of being used on targets coming into close proximity to the user without a substantially risk of injury to the user when the device is used properly has been discovered.

In one configuration, the device includes a variable output resistor and an output voltage switch which can be manipulated to provide varying output voltages. In another embodiment, a voltage supply may be changed to provide varying output voltages.

It is understood that other embodiments of the present invention will become readily apparent to those skilled in the art from the following detailed description, wherein only various embodiments of the invention are described and shown by way of illustration. As will be realized, the invention is capable of other and different embodiments and its several details are capable of modification in various other respects, all without departing from the spirit and scope of the present invention. Accordingly, the drawings and detailed description are to be regarded as illustrative in nature and not as restrictive.

Embodiments of the present invention advantageously provide a submersible protection device comprising a housing, at least two electrically conductive probes, an electric circuit, and a voltage supply. The housing defines a substantially fluid tight chamber therein, and the at least two electrically conductive probes extend from the housing. The electric circuit is disposed in the substantially fluid tight chamber of the housing and is in electrical communication with the electrically conductive probes. The electric circuit is adapted to provide an output voltage to the electrically conductive probes in the range of about 80,000 volts to about 160,000 volts, and the electric circuit adapted to provide an output current to the electrically conductive probes of less than about 500 milliamps. The voltage supply delivers an input voltage to the electric circuit.

### BRIEF DESCRIPTION OF DRAWINGS

Various aspects of a submersible protection device are illustrated by way of example, and not by way of limitation, in the accompanying drawings, wherein:

FIG. 1 is a front view of a submersible protection device in accordance with the principles of the present invention;

FIG. 2 is a side view of the device of FIG. 1;

FIG. 3 is a schematic of an electric circuit for the device of FIGS. 1 and 2; and

FIG. 4 is a front view of a submersible protection device in accordance with another embodiment of the present invention.

### DETAILED DESCRIPTION OF INVENTION

The detailed description set forth below in connection with the appended drawings is intended as a description of various embodiments of the invention and is not intended to represent the only embodiments in which the invention may be practiced. The detailed description includes specific details for the purpose of providing a thorough understanding of the invention. However, it will be apparent to those skilled in the art that the invention may be practiced without these specific details. In some instances, well known structures and components are shown in block diagram form in order to avoid obscuring the concepts of the invention.

In the description that follows, a submersible protection device is described that is useful for electrically shocking an aquatic animal or other target (hereafter “target”) that is located in close proximity to a user of the device. In general, the term “target” is meant to encompass a wide variety of aquatic animals, as well as other objects that the user may desire to electrically shock, such as another human being posing a physical threat to the user, for example. It shall be understood that the target to be shocked need not physically touch the device in order to be shocked, as the electrical discharge emitted by the device can travel a distance outwardly from the device.

The description also provides a specific example that includes exemplary dimensions. This example is provided as a way to show the relative dimensions of the structure of the present submersible protection device and is not intended to limit the invention only to the specific dimensions described.

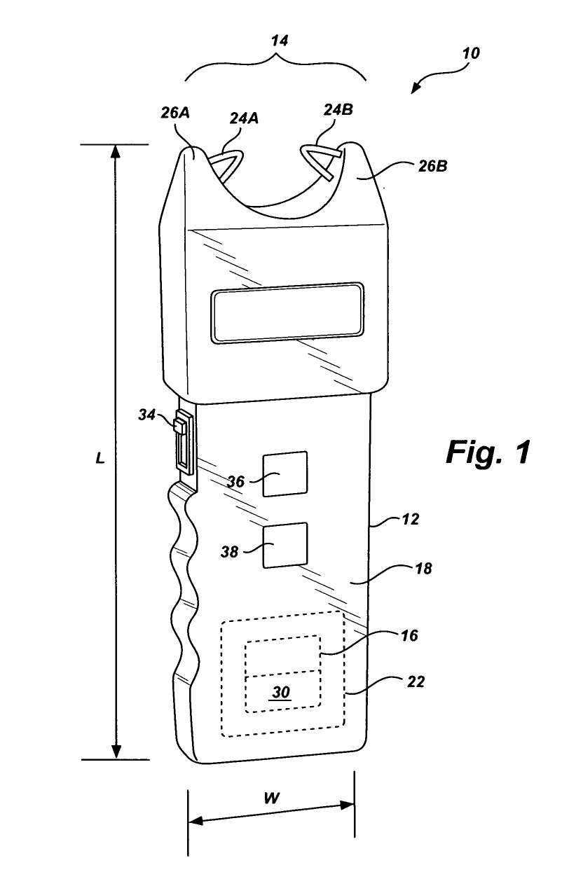

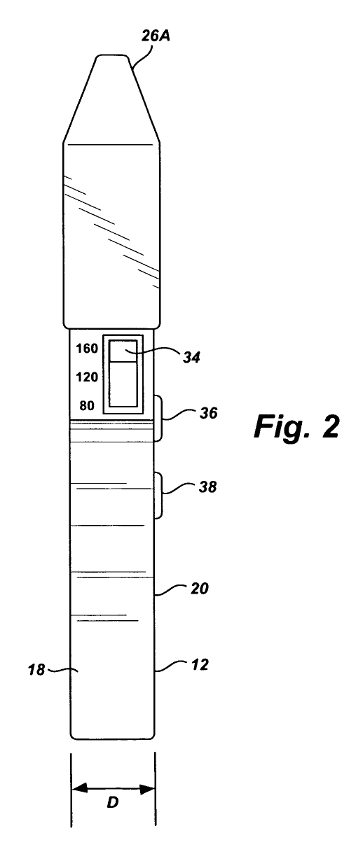

Referring to the drawings, FIGS. 1 and 2 illustrate a submersible protection device 10 in accordance with the principles of the present invention. The device 10 comprises a housing 12, an electrical discharge portion 14, and an electric circuit 16. As will be described in greater detail below, the device 10 can be used by a user (not shown), such as a diver, for example, for protection against one or more targets (not shown).

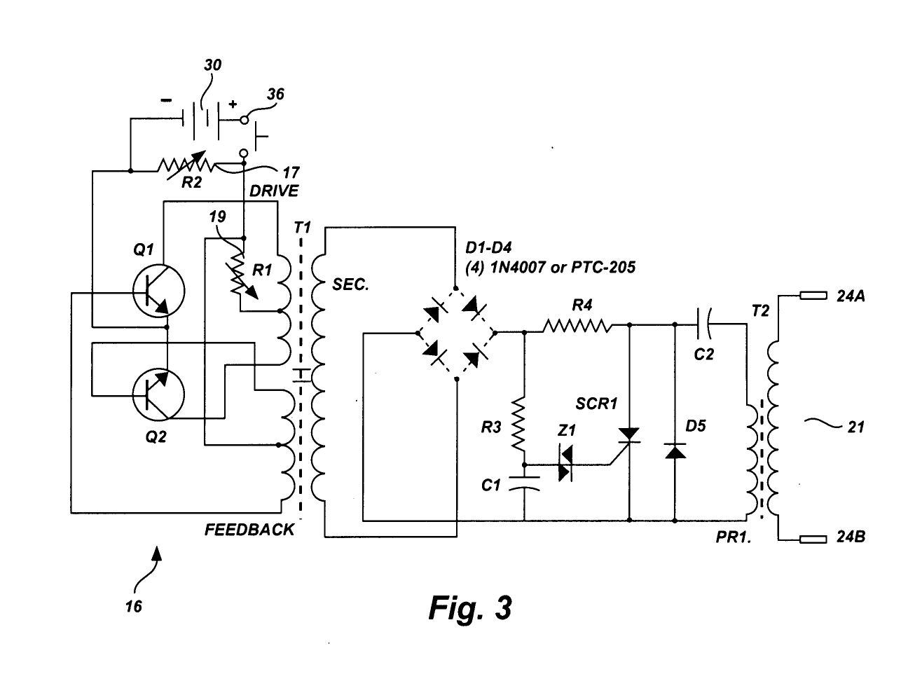

The housing 12 is formed from a water resistant and non-conductive material, such as a polymeric material, for example, although any suitable type of water resistant and non-conductive material could be used to form the housing 12 as desired. In the embodiment shown in FIGS. 1 and 2, the housing 12 has a length L of about 8 to 10 inches, although the housing 12 may have any suitable length, but is preferably between about 4 inches and about 12 inches to provide safety benefits and the ability to be used on targets coming into close proximity to the user. A width W of the housing 12, shown in FIG. 1, may be any suitable width such that the device 10 can contain the circuitry shown in FIG. 3 and can be operated by the user with only one hand, but is preferably between about 2 inches and about 4 inches. A depth D of the housing 12, shown in FIG. 2, may be any suitable depth such that the device 10 can contain the circuitry shown in FIG. 3 and can be operated by the user with only one hand, but is preferably between about 0.5 inches and about 2.5 inches. In a preferred embodiment, the housing 12 is configured to allow operation of the device 10 by the user with only one hand.

As shown in FIGS. 1 and 2, the device 10 has a generally parallelepiped shape, but may have any suitable shape as desired, such as wherein the device 10 is contoured to fit more comfortably in the hand of the user. Further, the device 10 may include curved indentations along the length L of the housing 12, such that the device 10 can be grasped more securely by the fingers of the user, even if gloved.

As shown in FIG. 2, the housing 12 comprises a first portion 18 sealed to a second portion 20 such that a substantially fluid tight chamber 22 is defined at an interface therebetween. It is understood that the housing 12 could be formed from a single piece of material having a chamber formed therein within the spirit and scope of the invention. Any suitable method may be used to seal the first portion 18 to the second portion 20, provided that the chamber 22 is substantially fluid tight. In a preferred embodiment, the housing 12 is configured such that the chamber 22 is substantially fluid tight and therefore waterproof down to a depth of about 300 feet below the surface of a lake or an ocean, for example, that the device 10 is being utilized in.

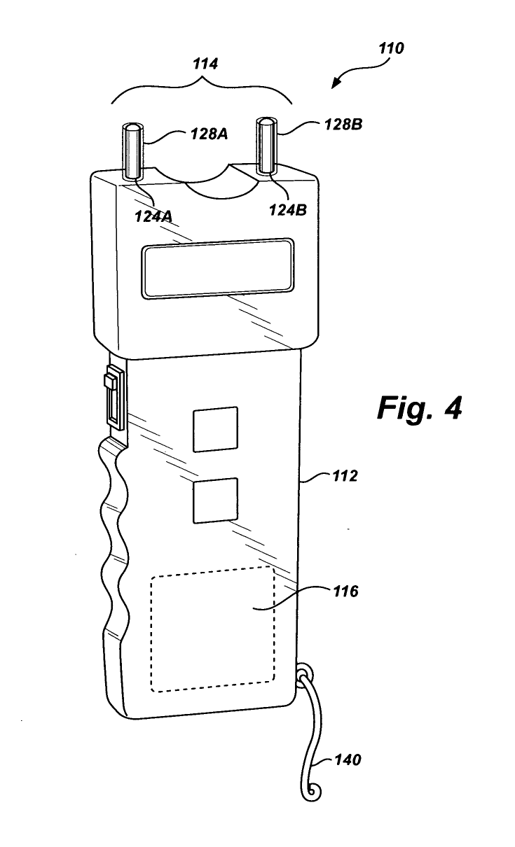

The electrical discharge portion 14 of the device 10 comprises a plurality of electrically conductive probes or electrodes 24A, 24B (two shown in FIG. 1). The probes or electrodes 24A, 24B may be any suitable type of electrically conductive probe that is capable of emitting an electrical discharge. In the embodiment shown in FIG. 1, the probes 24A, 24B extend about ¾ of an inch outward from opposing respective tabs 26A, 26B of the housing 12. As shown, they may be angled towards one another, while angles less than 45 degrees still allow operation of the device 10, the more the electrodes or probes 24A, 24B extend perpendicular to the major axis of the housing 12, the more the electric charge will be directed forwards of the device 10. Accordingly, it is understood that the probes 24A, 24B could extend axially outwardly from the housing 12 if desired and such an embodiment is described in relation to FIG. 4.

FIG. 3 is a schematic illustration of an exemplary electric circuit 16 which may be included in the chamber 22 of the housing 12 to provide an output voltage 21 and an output current to the probes 24A, 24B. The circuit 16 is in electrical communication with a voltage supply 30, which may be located in the chamber 22 of the housing 12, as shown in FIGS. 1 and 2, or may be located remotely from the housing 12 and connected to the circuit 16 through insulated and waterproof electrical leads (not shown), for example. The voltage supply 30 delivers an input voltage to the circuit 16 to be used in emitting the electrical discharge from the probes 24A, 24B. In the circuitry of FIG. 3, the input voltage is between about 18 volts and about 27 volts, but other suitable voltages may be used, based on the specific circuit components, to achieve the operating voltages and currents described below.

In the embodiment shown in FIG. 3, the circuit 16 includes a variable, selectable resistor (for example, either 17, 19 or the combination of both) whose value controls the output voltage at the probes 24A, 24B. In general it is understood that by changing the input voltage delivered from the power supply, the output voltage to the probes 24A, 24B can be varied. In the embodiment of FIG. 3, the output voltages at the probes 24A, 24B are selectable between about 80,000 volts, about 120,000 volts, and about 160,000 volts by selecting an appropriate value for the variable resistor 17 (or 19). Output current provided from the circuit 16 to the probes 24A, 24B can be as low as about 100 milliamps; however, it is understood that the voltages and currents provided from the circuit 16 to the probes 24A, 24B can vary, but are preferably the voltages are between about 80,000 volts to about 160,000 volts, and the currents are below about 500 milliamps. The behavior of the remaining circuitry included in the circuit 16 will be readily apparent to those skilled in the art and are not described in detail herein.

In use, the desired output voltage to be provided from the circuit 16 to the probes 24A, 24B is selected by the user adjusting a switch 34 that is disposed on the housing 12 and is in communication with the circuit 16. As shown in FIG. 2, the switch 34 includes respective positions for an 80,000 volt output, a 120,000 volt output, and a 160,000 output to correspond with the plurality of output voltages provided from the circuit 16 to the probes 24A, 24B that are facilitated by the variable, selectable resistor 17 (or 19). It is understood that other means for selecting the desired output voltage could be used, such as, for example, a dial or a slide mechanism that would allow the output voltages to be any value between minimum and maximum settings instead of only being selectable from between fixed output voltage values. It is also understood that changing the value of the voltage supply 130 will affect the output voltage 21 as well. For example, by selecting the appropriate battery or combination of batteries, the voltage supply can vary from about 18V to about 27 V and provide enough current, at output voltages between 80 kV and 160 kV, to effectively but safely protect a user of the device 10.

The device 10 is powered on and off by the user depressing a power button 34, which is located on the housing 12 and is in communication with the circuit 16. As will be readily apparent to those skilled in the art, other means for powering the device 10 on and off could be used without departing from the spirit and scope of the invention. Once the device 10 is powered on, the user depresses a trigger 36 that is also disposed on the housing 12 and is in communication with the circuit 16. When the trigger 36 is depressed, the output voltage and the output current are provided from the circuit 16 to the probes 24A, 24B, which emit an electrical discharge outwardly therefrom. It is understood that the location of the trigger 36 shown in FIGS. 1 and 2 is exemplary and not vital to the spirit and scope of the invention, although it is suggested that the trigger 36 be offset from the discharge portion 14 a sufficient distance such that the user of the device is not injured by the electrical discharge emitted from the probes 24A, 24B. In some embodiments it has been discovered that as long as the user's hand is behind the discharge region 14, there is little danger of injury.

The electrical discharge emitted from the probes 24A, 24B electrically shocks the target. It has been discovered that the device 10, at the exemplary operating parameters discussed above, is capable of emitting an electric shock in salt-water to a target located within about 4 inches of the device 10, and that and the device 10 is capable of emitting an electric shock in fresh-water to a target located within about 5 inches of the device 10. While the device 10 electrically shocks the target, the target is ideally incapacitated or deterred from the location of the device 10 and the user. Accordingly, the device 10 provides protection for the user from the target. Provided that the user properly uses the device 10 (i.e. the user does not come into close proximity to the discharge portion 14 of the device 10), the user ideally remains substantially unharmed by the device 10. It is noted the electrical discharge has been discovered to travel generally axially outwardly from the probes 24A, 24B of the device 10, and not in a direction back toward the user.

Since the length L of the device 10 is shorter than typical prior art underwater electrical discharge protection devices, the device 10 may be used when targets are in very close proximity to the user where such prior art devices would not be effectively usable for their associated electrical discharge function. Further, since the output current emitted from the probes 24A, 24B is sufficiently lower than that emitted by prior art devices, risk of injury to the user is believed to be substantially reduced. Additionally, since the device 10 can be used with only one hand, the other hand of the user is free to perform other functions. Thus, unlike prior art devices, the present device 10 is configured to be used one-handed and even if two hands are used, the present device 10 is usable even when the target is in close proximity to the user.

FIG. 4 illustrates a submersible protection device 110 in accordance with another embodiment of the present invention. The device 110 comprises a housing 112, an electrical discharge portion 114, and an electric circuit 116. The housing 112 and electric circuit 116 are substantially similar to the housing 12 and electric circuit 16 described above for FIGS. 1-3 and will not be described in detail for this embodiment.

The electrical discharge portion 114 comprises a plurality of electrically conductive probes or electrodes 124A, 124B (two are shown in FIG. 4). The probes or electrodes 124A, 124B may be any suitable type of electrically conductive probe that is capable of emitting an electrical discharge. In the embodiment shown in FIG. 4, the probes 124A, 124B extend about ¾ of an inch axially outwardly from the housing 112. However, longer probes are also contemplated within the scope of the present invention.

Optionally, as illustrated in FIG. 4, the probes 124A, 124B may include electrically insulating sheaths 128A, 128B associated therewith, such that only the ends of the probes 124A, 124B are exposed. The electrically insulating sheaths 128A, 128B may be formed from any suitable type of insulating material that will also withstand both being submersed in water and the repeated electrical shocks. The sheaths 128A, 128B may also be slightly deformable such that if the device 110 is pressed into a target, the electrodes 124A, 124B will be permitted to contact the surface of the target. Electrically insulating sheaths 128A, 128B are not a necessary part of the present invention and thus need not be present for proper function of the device 110.

Use of the device 110 is substantially similar to use of the device 10 described above. However, the device 110 in FIG. 4 includes an associated structure 140, such as a lanyard, for example, for retaining the device 110 in the possession of the user. The structure 140 could be attached to the user, such as looped around the hand/wrist of the user or attached to a gear worn by the user, for example. The structure 140 may be useful in situations where the device 110, if accidentally dropped by the user, may otherwise result in the loss of the device 110, such as in deep water.

The previous description is provided to enable any person skilled in the art to practice the various embodiments described herein. Various modifications to these embodiments will be readily apparent to those skilled in the art, and the generic principles defined herein may be applied to other embodiments. Thus, the claims are not intended to be limited to the embodiments shown herein, but are to be accorded the full scope consistent with each claim's language, wherein reference to an element in the singular is not intended to mean “one and only one” unless specifically so stated, but rather “one or more.” All structural and functional equivalents to the elements of the various embodiments described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A submersible protection device comprising:
a housing defining a substantially fluid tight chamber therein;
at least two electrically conductive probes extending from the housing;
an electric circuit disposed in the substantially fluid tight chamber of the housing and in electrical communication with the electrically conductive probes, the electric circuit adapted to provide an output voltage to the electrically conductive probes in the range of about 80,000 volts to about 160,000 volts and the electric circuit adapted to provide an output current to the electrically conductive probes of less than about 500 milliamps; and
a voltage supply for delivering an input voltage to the electric circuit.

2. The protection device of claim 1, wherein the substantially fluid tight chamber is substantially waterproof down to a depth of about 300 feet.

3. The protection device of claim 1, wherein a length of the housing is between about 4 inches and about 12 inches.

4. The protection device of claim 1, wherein the housing comprises a first portion that is sealed to a second portion.

5. The protection device of claim 1, wherein the electrically conductive probes extend from the housing about ¾ of an inch.

6. The protection device of claim 1, further comprising a respective electrically insulating sheath associated with each of the electrically conductive probes.

7. The protection device of claim 1, wherein the device is capable of emitting an electric shock in salt-water to a target located within about 4 inches of the device.

8. The protection device of claim 1, wherein the device is capable of emitting an electric shock in fresh-water to a target located within about 5 inches of the device.

9. The protection device of claim 1, wherein the output voltage provided by the electric circuit is adjustable.

10. The protection device of claim 9, wherein the adjustable output voltage provided by the electric circuit is facilitated by varying a voltage of the voltage supply.

11. The protection device of claim 9, further comprising structure associated with the housing and in electrical communication with the electric circuit for manually adjusting the output voltage.

12. The protection device of claim 1, wherein the input voltage delivered to the electric circuit by the voltage supply is between about 18 volts to about 27 volts.

13. The protection device of claim 1, wherein the housing is configured to allow operation of the device with only one hand.

14. A submersible protection device comprising:
a housing defining a substantially fluid tight chamber therein, the housing formed from a non-conductive material and having a length between about 4 inches and about 12 inches;
at least two electrically conductive insulated probes extending from the housing;
an electric circuit disposed in the substantially fluid tight chamber of the housing and in electrical communication with the electrically conductive insulated probes, the electric circuit adapted to provide an adjustable output voltage and an output current to the electrically conductive insulated probes; and
a voltage supply for delivering an input voltage to the electric circuit.

15. The protection device of claim 14, wherein the substantially fluid tight chamber is substantially waterproof down to a depth of about 300 feet.

16. The protection device of claim 14, wherein, the electric circuit provides an output voltage to the electrically conductive insulated probes in the range of about 80,000 volts to about 160,000 volts, the electric circuit provides an output current to the electrically conductive insulated probes of less than about 500 milliamps, and the input voltage delivered to the electric circuit by the voltage supply is between about 18 volts to about 27 volts.

17. The protection device of claim 14, wherein the device is capable of emitting an electric shock in salt-water to a target located within about 4 inches of the device and the device is capable of emitting an electric shock in fresh-water to a target located within about 5 inches of the device.

18. The protection device of claim 14, wherein the adjustable output voltage provided from the electric circuit is facilitated by one of varying a voltage of the voltage supply and a variable resistor included in the electric circuit.

19. The protection device of claim 14, further comprising structure associated with the housing and in electrical communication with the electric circuit for manually adjusting the output voltage.

20. A submersible protection device comprising:
a housing including a first portion that is sealed to a second portion such that a substantially fluid tight chamber is defined therebetween, a length of the housing between about 4 inches and about 12 inches such that the device can be operated with only one hand, wherein the substantially fluid tight chamber is substantially waterproof down to a depth of about 300 feet;
at least two electrically conductive probes extending from the housing;
an electric circuit disposed in the substantially fluid tight chamber of the housing and in electrical communication with the electrically conductive probes, the electric circuit adapted to provide an output voltage to the electrically conductive probes in the range of about 80,000 volts to about 160,000 volts and the electric circuit adapted to provide an output current to the electrically conductive probes of less than about 500 milliamps; and
a voltage supply for delivering an input voltage to the electric circuit in the range of about 18 volts to about 27 volts;
wherein the device is capable of emitting an electric shock in salt-water to a target located within about 4 inches from the device and the device is capable of emitting an electric shock in fresh-water to a target located within about 5 inches from the device.
